(19) United States
(12) Patent Application Publication
(10) Pub. No.: US 2026/0087260 A1
(43) Pub. Date: Mar. 26, 2026

(54) USING ARTIFICIAL INTELLIGENCE MODELS TO DETECT AND MITIGATE AMBIGUITY IN NATURAL LANGUAGE TEXT

(71) Applicant: MicroStrategy Incorporated, Vienna, VA (US)

(72) Inventors: Ananya Ojha, Dunn Loring, VA (US); Jingbin Zhang, Hangzhou (CN); Tingting Jin, Vienna, VA (US); Jaime Alberto Perez, Brambleton, VA (US); Mingmin Sun, Vienna, VA (US); Abdul Rahman, Warsaw (PL); Divya Singh, Chantilly, VA (US); Jose Nocedal, Leesburg, VA (US); Luke Lasich, Vienna, VA (US)

(21) Appl. No.: 19/193,781

(22) Filed: Apr. 29, 2025

Related U.S. Application Data
(63) Continuation-in-part of application No. 19/191,684, filed on Apr. 28, 2025.
(60) Provisional application No. 63/697,439, filed on Sep. 20, 2024.

(51) Int. Cl. G06F 40/35; G06F 40/289; H04L 51/02

(52) U.S. Cl. CPC G06F 40/35; G06F 40/289; H04L 51/02

(57) ABSTRACT

Methods, systems, and apparatus, including computer-readable media, for using artificial intelligence models to detect and mitigate ambiguity in natural language text. In some implementations, a system receives a text input from a user. The system classifies the text input as containing an ambiguity. Based on classifying the text input as containing an ambiguity, the system sends (i) a response to the text input generated using a first interpretation or meaning and (ii) one or more alternative interpretations or meanings. The system receives data indicating user input that selects one of the one or more alternative interpretations, and in response the system sends a second response generated using the selected alternative interpretation or meaning.

### CROSS-REFERENCE TO RELATED APPLICATIONS

This application claims the benefit of priority to U.S. Provisional Patent Application No. 63/697,439 , filed on Sep. 20, 2024, and this application is a continuation-in-part of U.S. patent application Ser. No. 19/191,684, filed on Apr. 28, 2025, and the entire contents of each of the previous applications is hereby incorporated by reference herein.

### BACKGROUND

The present specification relates to techniques for using models for artificial intelligence and machine learning to detect and mitigate ambiguity in natural language text.

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users.

### SUMMARY

In some implementations, a computer system users AI/ML models to detect and mitigate ambiguous statements in natural language text. For example, the computer system can provide a chatbot interface that receives prompts (e.g., questions, requests) from users in natural language, and provides responses generated by one or more AI/ML models. Many times, the user's input prompt is vague or ambiguous, so that there are potentially multiple interpretations or multiple types of valid answers. The system can use various techniques to improve communication even in the presence of ambiguous prompts or other inputs.

As an example, a user may ask a chatbot, “what are the 10 best movies?,” but it is unclear what criteria should be used to determine what “best” means in this context. Further, the appropriate meaning may vary from user to user. For example, one user may consider the best movies to be those with the highest audience ratings, another user may consider the best movies to be those with the best ratings from movie critics, another user may consider the best movies to be those that performed the best financially (e.g., highest total box office sales), and so on. An answer based on any of these interpretations is a valid answer to the question, but they may not provide the answer the user intended when the user submitted the prompt.

One techniques the system can use is to include a bias or configuration so that the system provides an answer to the user based on a possible or likely interpretation, even when ambiguity is present. By instructing an AI/ML model, such as a large language model (LLM), to provide at least some answer for a prompt that is unclear can reduce the latency of delivering a response to the user and can improve the pace of the conversation.

In addition, the system can instruct the AI/ML model to inform the system when ambiguity is present or additional information would be needed, even when this is provided together with a likely answer that the AI/ML model provides. When ambiguity is detected, the system can initiate a further interaction with the AI/ML model to identify possible interpretations for an ambiguous term or concept, even before the user provides further input. For example, after or during the presentation of an answer to a prompt detected to contain ambiguity, the system can initiate an additional round of interaction with the AI/ML model to request content such as (1) different potential meanings of the ambiguous term or concept, and (2) a response corresponding to each of the potential meanings or at least a few (e.g., 3, 5, etc.) of the most probable meanings of the ambiguous term or concept. Then, using the output of the AI/ML model for this additional round of communication, initiated by the system and not by any further prompt of the user, the system can supplement the initial answer provided to the user with additional information that answers the user's original prompt according to the different interpretations.

As an example, in the case of the prompt “what are the 10 best movies,” the system may coordinate with the AI/ML model to generate and provide a first chatbot response to the user, such as “According to this movie ranking web site, the top 10 movies are . . . ” The response from the AI/ML model may indicate to the system that ambiguity is detected, and potentially that the ambiguity is about the criteria for determining what is “best” in the context of movies. In response, the system can send a request to the AI/ML model, requesting that the AI/ML model identify the top three alternative interpretations for “best” in this context and providing an answer for each of the three alternative interpretations. The system initiates this further request based on the indication that ambiguity is present, and not in response to any further user prompt, since the user has not yet responded to the results. The AI/ML model then responds by providing the requested alternative answers, each based on a different interpretation of the ambiguous term “best.” The system can provide these three additional answers to the user in one or more supplemental responses to the user's original question. For example, “The top 10 movies by film critic rating are . . . ,” “The top 10 movies by audience rating are . . . ,” and “The top 10 movies by box office sales totals are . . . ” The system, by automatically providing these supplemental results, has provided information that is much more likely to satisfy the user's original intent when the prompt was made. In addition, these results are provided without requiring the user to make any further prompt or request. In addition, the user receives an initial response with very quickly, and can be reviewing that answer in parallel with generation of the alternative answers, which results in very high responsiveness and low perceived latency by the user.

The system can use the alternative answers (e.g., answers based on alternative criteria or alternative interpretations of an ambiguous term) as a way to build contextual knowledge. For example, the system can ask the user “did you mean . . . ” and provide the alternative answers, allowing the user to select whether one of the alternatives captures the meaning or criteria the user intended. The system can make the alternative answers interactive (e.g., selectable, as buttons or other controls). If the user selects one of the alternative answers, the system learns from the user's affirmative indication of the preferred answer. For example, the system can store a setting or record that indicates that, for the current context (e.g., the topic of movies), the “best” movies should be interpreted with the criteria used for the selected answer (e.g., criteria of “highest audience score” if the user selects the answer defined according to audience score).

The system can use similar techniques to provide supplemental content when the user submits a prompt or question that is open-ended or generally vague or not well defined. For example, after a user asks a question to a chatbot, the user may submit a subsequent session that is very broad or open-ended, such as “tell me more about that,” “is there anything more?,” “how about [Metric]” (where “[Metric]” here represents the name or type of data for a data object in a database, etc.). In some cases, the broad or open-ended question may be the initial question, and so may occur without the benefit of any prior context of the conversation. The system can be configured to identify open-ended questions and answer these questions effectively with summarized information.

In a similar way that the system leverages the AI/ML model to determine if a prompt is ambiguous, the system can also ask if the user's prompt is open-ended. The AI/ML model (e.g., LLM) can analyze the question's structure, key phrases, and contextual cues based on the underlying data set (e.g., database content) to detect if a question is open-ended. Once an open-ended question is identified, the system uses the AI/ML model to generate an in-depth commentary addressing the primary query across a predetermined number of aspects, such as three aspects. The response can be wide-ranging yet closely related to the original query, if one exists.

Using the AI/ML model, the system can treat ambiguous questions and open-ended questions as separate categories, with separate response types generated in response. For example, when the AI/ML model classifies a question as ambiguous, the system instructs the AI/ML model to generate multiple alternative answers (e.g., based on alternative interpretations) are provided. By contrast, when the AI/ML model classifies a question as open-ended, the system instructs the AI/ML model to generate an answer that describes multiple separate aspects of a topic. In other words, the answers for an ambiguous question can be different interpretations of a single data object (e.g., a metric or attribute) with different criteria applied to the data object. The answer to an open-ended question can include information for each of multiple different data objects (e.g., several different metrics or attributes) related to a topic.

Both ambiguous and open-ended questions have potential to generate diverse responses, but there is a large difference in terms of intent. Open-ended questions are deliberate on the part of the user, when the user wants to encourage the chatbot to give more expansive answers. On the other hand, ambiguous questions typically result from poor phrasing or lack of specificity. Open ended questions can and should generate valuable responses that can be further drilled down, whereas ambiguous questions are obstacles to clear answers and require more clarification to ensure the final answer is more meaningful or actionable for the user.

The computer system can support interactive applications where processing tasks for responding to a user prompt are split between non-AI/ML or non-probabilistic data processing systems (e.g., database management systems) and AI/ML models. For example, when a user prompt such as a natural language query is received, the computer system can use a database system to generate a set of result data that is relevant to the user prompt. The set of result data can then be processed using one or more AI/ML models, such as a large language model, to generate content to present in a response to the user. This system can combine the strengths of AI/ML models and non-AI/ML processing systems to provide a chatbot or other application with responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. In some cases, AI/ML models provide content that includes hallucinations or other information that may be statistically plausible given training data but is actually factually incorrect. The probabilistic nature of AI/ML models can also result in the same user prompt resulting in significantly different responses at different times, which can decrease users' confidence and ability to rely on the responses. For example, the same question may yield different numerical answers when the question is asked multiple times to an AI/ML model, even when the source data set has not changed.

As discussed further below, the computer system can provide chatbots and other interactive applications that combine the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data.

When the interactive application is used to respond to a user prompt, the non-AI/ML data processing system (e.g., a database management system) generates result data relevant to the user prompt (e.g., user's question) from the source data set. The user prompt and the result data set, potentially with other information and context, can be provided to the AI/ML model to generate text output for the response to the user. For example, the computer system can send a request for the AI/ML model to summarize the result data set or to generate a response to the original user prompt from the result data set that has been generated. As a result, the text that the AI/ML model generates can draw from values calculated accurately from the source data set, without requiring the AI/ML model to be capable of generating those values itself or without the AI/ML model even accessing the data set. As a result, the output to the user combines the reliable, accurate calculations from the non-AI/ML system with the text and other information provided by the AI/ML model from the result data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata describing the general contents and/or structure of the data set (e.g., types of metrics and attributes, semantic meaning of the columns, etc.) and potentially sample data (e.g., fictitious examples that illustrate the type of content in the dataset without revealing the actual values and records). In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying. After the data processing system performs processing to generate a result data set, the AI/ML model is provided the result data set and asked to generate a summary. In this interaction, the AI/ML model receives the result data set that generally includes aggregated or composite information specifically answering the user's question, and the AI/ML model does not receive access to the underlying dataset itself. As a result, the system avoids granting the AI/ML model—and any third-party providing the AI/ML model as a service—access to portions of the dataset that are not appropriate for answering the current question.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers to customize their chatbots. With the system performing discrete operations leveraging AI/ML models, separate from the core querying of an enterprise's proprietary datasets, the chatbots can be more easily integrated with the processing capabilities of third-party systems.

In one general aspect, a method performed by one or more computers comprises: receiving, by the one or more computers, a text input from a user, wherein the text input is received over a communication network from a client device; classifying, by the one or more computers, the text input as containing an ambiguity; based on classifying the text input as containing an ambiguity, sending, by the one or more computers and to the client device, (i) a response to the text input generated using a first interpretation or meaning and (ii) one or more alternative interpretations or meanings that each resolve the ambiguity differently than the first interpretation or meaning; after sending the response and the one or more alternative interpretations, receiving, by the one or more computers, data indicating user input that selects one of the one or more alternative interpretations; and in response to receiving the data indicating the user input, sending, by the one or more computers and to the client device, a second response generated using the selected alternative interpretation or meaning.

In some implementations, the method includes, in response to receiving the user input, storing data indicating the selected alternative interpretation or meaning in association with a user identifier for the user. The one or more computers are configured to use the selected alternative interpretation or meaning to respond to future input from the user.

In some implementations, storing the data indicating the selected alternative interpretation or meaning comprises storing text representing the selected alternative interpretation or meaning in a vector database.

In some implementations, storing the text representing the selected alternative interpretation or meaning comprises: generating a vector embedding of the text representing the selected alternative interpretation or meaning; and storing the text representing the selected alternative interpretation or meaning in association with the vector embedding.

In some implementations, the ambiguity corresponds to a term or concept of the text input; the method includes, after storing the data indicating the selected alternative interpretation or meaning in association with a user identifier for the user: receiving a second text input from the user, wherein the second text input includes the term or concept; selecting the stored text representing the selected alternative interpretation or meaning based on the second text input; and using the stored text representing the selected alternative interpretation to generate a response to the second text input.

In some implementations, selecting the stored text representing the selected alternative interpretation comprises: generating a vector embedding for the second text input; evaluating similarity or distance of the vector embedding for the second text input with respect to vector embeddings of stored items associated with the user; and selecting the stored text representing the selected alternative interpretation based on similarity of the vector embedding for the second text input and a vector embedding of the text representing the selected alternative interpretation or meaning.

In some implementations, the method includes, in response to receiving a second text input from the user in a different session or conversation than the one in which the text input was provided, performing result-augmented generation (RAG) including (i) selectively retrieving one or more items saved based on user interactions with a chatbot from a vector database, and (ii) generating a response to the second text input based on the retrieved one or more items.

In some implementations, the one or more retrieved items are each text segments, and wherein generating the response to the second text input comprises providing the second text input and the one or more retrieved items to a artificial intelligence and/or machine learning model to generate the response to the second text input.

In some implementations, the method includes causing one or more interactive user interface elements corresponding to each of the one or more alternative interpretations or meanings to be displayed at the client device, wherein the one or more interactive user interface elements are each selectable to designate a corresponding alternative interpretation or meaning to be used.

In some implementations, the one or more alternative interpretations or meanings comprise multiple alternative interpretations or meanings.

In some implementations, the first interpretation or meaning and the alternative interpretations or meanings each comprise at least one of: a mapping of a terms to a data object of a data model or data set; one or more criteria for sorting, filtering, or ranking; or a threshold value.

In some implementations, the text input is a user prompt entered in a chatbot interface.

In some implementations, classifying the text input comprises sending a request for an artificial intelligence and/or machine learning (AI/ML) model to classify the text input.

In some implementations, the request includes a request to indicate whether the text input corresponds to one of multiple different categories that include a category of an ambiguous question and a category of an open-ended question.

In some implementations, classifying the text input comprises requesting for an artificial intelligence and/or machine learning (AI/ML) model to (i) identify an ambiguous term or concept from the text input, (ii) determine multiple interpretations for the ambiguous term or concept, and (iii) provide responses to the corresponding to each of two or more of the multiple interpretations; and the one or more alternative interpretations include interpretations indicated by the AI/ML model.

In some implementations, sending the second response comprises sending a response based on a response that corresponds to the selected one of the one or more alternative interpretations, wherein the second response was generated by the AI/ML model before the one or more alternative interpretations were sent to or displayed to the user. In many cases, having the responses from the AI/ML model in advance, e.g., before the user selects a different interpretation, decreases latency experienced by the user and is more efficient by reducing the number of requests to the AI/ML model that need to be performed.

In some implementations, the method includes, in response to user selection of one of the alternative interpretations, storing and reusing the interpretation for the user in a later session or conversation.

In some implementations, the text input is a user prompt to a first chatbot; wherein the method includes later retrieving the stored interpretation and using the retrieved interpretation to generate a response from a second chatbot to provide to the user.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for using artificial intelligence or machine learning (AI/ML) models to detect and mitigate ambiguity in natural language text, as well as other types of uncertainty such as open-ended questions.

FIGS. 2-5 are diagrams showing examples of user interfaces where the system handles ambiguous questions.

FIGS. 6-11B are diagrams showing examples of user interfaces where the system handles broad or open-ended questions.

Like reference numbers and designations in the various drawings indicate like elements.

### DETAILED DESCRIPTION

In some implementations, a computer system includes features to classify questions or prompts submitted by a user, and to change the content and characteristics of the response based on the classification. For example, the system can provide a prompt to an AI/ML model and ask the model to classify whether the prompt includes an ambiguous question, an open-ended question, or a standard question (e.g., neither ambiguous nor open-ended). The system can then be configured to perform different processing workflows, or to use different instructions to an AI/ML model for generating a response, based on the classification.

One aspect of the technique is to provide users with smart alternative answers for their queries when ambiguity is detected. This ensures that, alongside a default answer, the chatbot presents alternative answers based on alternative interpretations. This can be provided in a supplemental answer that asks the user, “Did you mean?” and then shows one or more answers based on alternative interpretations. The alternative answers can be designed to clarify ambiguity, by using interpretations that cause the answer to diverge and become evident to the user. This enables a more tailored and accurate response to the user's original question.

As an example of an ambiguous query, a user may ask “Show me the top three best-performing employees.” The dataset has metrics such as “Revenue Generated”, “quarterly performance score”, “new customers acquired”, “YoY, Revenue growth”, and “customer satisfaction score,” but there is no criteria defined in advance for how to select the best employees. The system initially provides a default answer: “Top 3 employees by quarterly performance score are X, Y, and Z”. The system then also provides several alternative answers, as suggestions that may more closely align with the user's intent, “Did you mean: Top three employees by revenue generated are . . . Top performers based on new customer acquisition in the last year are . . . Best-performing employees in terms of customer satisfaction in 2023 are . . . ”

Open-ended questions are also detected and are processed to produce a different type of output. Users sometimes ask broad or open-ended questions expecting a broader answer highlighting different insights or different types of information. To address this need, the system can be configured to detect open-ended questions and address them effectively. The feature can include a mechanism that detects open-ended inquiries and delivers comprehensive responses by elaborating on 2-3 key aspects of each question. For instance, a query such as “tell me about Sales in New York in 2023” could result in an overview of total sales numbers, revenue trends across the 12 months, and key factors affecting these figures.

The system can distinguish between ambiguous question and open-ended questions, and the system can differentiate the types of responses based on whether a question is classified by the system or an AI/ML model as ambiguous or open-ended. If a question is classified as neither ambiguous nor open-ended, then the system processes the question using a standard question-answering path, without the response processing and types of features designated specifically for the ambiguous questions or the open-ended questions.

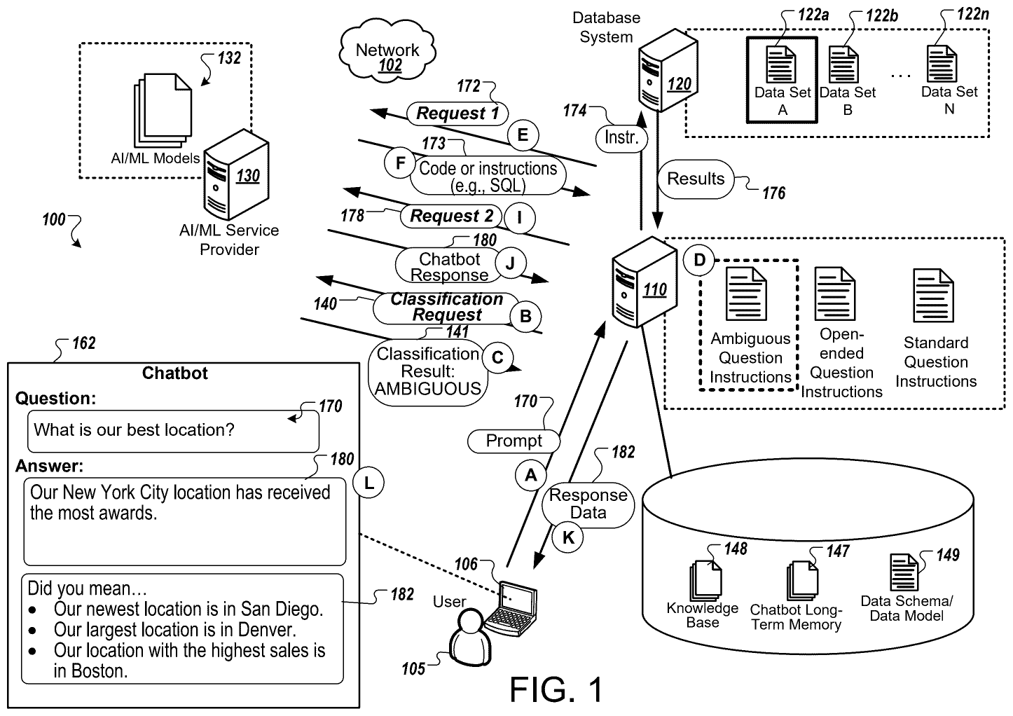

FIG. 1 is a diagram showing an example of a system 100 for detecting and mitigating ambiguity and open-ended questions in natural language text. The system 100 includes a computer system 110, a database system 120, and an AI/ML service provider 130. The system also includes a user device 106 of a user 105. The elements of the system 100 communicate over a network 102, such as the Internet. The computer system 110 coordinates a variety of operations to provide and manage access to chatbots and other AI/ML applications. In the example, the user 105 enters a user prompt 170 for a chatbot, and the computer system 110 coordinates the generation of the answer by the chatbot, including a text response 180 generated by an AI/ML model 132. The example of FIG. 1 includes stages (A) to (L), which represent various operations and a flow of data, and which can occur in the order illustrated or in a different order.

The computer system 110 can produce chatbot answers with high accuracy and high reliability by generating the chatbot's response to the prompt 170 using multiple interactions with the AI/ML model 132. When a user provides a prompt 170 (e.g., a question), the computer system 110 can make a classification request 140 that asks the AI/ML model 132 to classify whether the prompt 140 fits one or more categories, such as being ambiguous or open-ended. The AI/ML model 132 provides a classification result in response, and the computer system 110 then can adjust how it generates further responses (e.g., adjust the instructions provided to the AI/ML model 132 in subsequent interactions) based on the question type classification.

The computer system 110 can send other requests also. For example, for a chatbot that is separate from a document or dashboard, so there is no working set of result data present, the computer system 110 can send a first request 172 that requests that the AI/ML model 132 generate code or instructions 173 for retrieving and/or calculating values for answering the prompt 170. The first request 172 can request that the response be provided in a standardized format, such as structured query language (SQL) or another programming language. The computer system 110 then uses the code or instructions 173 (or a modified version shown as data processing instructions 174) to retrieve results 176 from one or more data sets of the database system 120.

The computer system 110 can then send the results 176 from the database system 120 to the AI/ML model 132 in a second request 178 to generate a response (e.g., a chatbot text response) to the prompt 170 that is based on the results 176. If the chatbot interface is shown in connection with a dashboard or other document, the steps of retrieving data from the database system 120 may be unnecessary, since the results 176 providing the values of interest may already be present (e.g., cached) or embedded in the document. In this case also, the computer system 110 sends the results 176 with an instruction appropriate for the question type to generate the response to the chatbot that is provided to the user.

The computer system 110 can be implemented using one or more servers, such as one or more cloud computing systems, one or more on-premises servers, etc. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface. The computer system 110 performs various other functions to generate and save customized chatbots, to manage and grant access to existing chatbots, and to coordinate the processing of user prompts to generate responses from the chatbots.

The database system 120 can provide various data retrieval and processing functions. For example, the database system 120 can be a database management system (DBMS), and can include the capability to process operations specified in structured query language (SQL), Python code, or in other forms. The database system 120 has access to various datasets 122a-122n, which can be private datasets for organization, such as a company. The database system 120 can store and use datasets in any of various forms such as tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

Chatbots can be provided by the computer system 110 or other systems, including third-party systems. Some or all of the chatbots may be executed or managed by the same server system or same operator as the computer system 110. Each chatbot can have an associated dataset 122a-122n (or multiple datasets) from which the chatbot derives responses to user. Each chatbot can also have a corresponding AI/ML model 132 designated to use for generating responses from the chatbot, such as a LLM. Each chatbot can also have a corresponding set of settings and customizations that specify various properties of the chatbot (e.g., text output tone and style, output format, verbosity, etc.). Different chatbots may use different datasets 122a-122n or share the same datasets 122a-122n, and similarly different chatbots may use different AI/ML models 132 or share the same AI/ML model 132. Each chatbot can also include functionality to store conversation histories for each user across different sessions of use. In other words, for the user 105, each chatbot can store a separate, persistent chat history for the interactions of the user 105.

Different users have access to different datasets 122a-122n and chatbots 108a-108n, depending on their roles, permissions, etc. The user 105 authenticates to the computer system 110, so that the user's identity is determined and the user's permissions can be determined.

In the example of FIG. 1A, in stage (A), a user 105 enters a prompt 170 in a chat user interface 162, and the client device 106 of the user 105 sends the user prompt 170 to the computer system 110 over the network 102. The user 105 accesses a chat user interface 162 for interacting with AI/ML chatbots using a user device 106 (e.g., a phone, a laptop computer, a desktop computer, etc.). For example, the chat interface 162 can be part of a web page, a web application, a native application on the user device 106. The chat interface 107 can be displayed based on user interface data provided by the computer system 110 or another server.

The user 105 interacts with the chat interface 107 to enter a user prompt 170, which in this example is the question, “What is our best location?”

In stage (B), the computer system 110 sends a classification request 140 to the AI/ML model 132, asking the AI/ML model 132 to indicate whether the user prompt 170 is classified as ambiguous or is classified as open-ended. The classification request 140 can include the user prompt 170, the instruction to classify the user prompt 170, and can include criteria explaining the classifications.

In stage (C), the computer system 110 receives a classification result 141 from the AI/ML model 132. In this example, the classification result 141 indicates that the user prompt 170 is not classified as open-ended, but that the user prompt 170 is classified as ambiguous. The classification result 141 can further specify that the term “best” is the ambiguous element, or that criteria for deciding this aspect is lacking.

In stage (D), the computer system 110 uses the classification result 141 to determine a response strategy that is appropriate for the question type. For example, the computer system 110 can store data that specifies different response content or response workflows that are selectively used depending on the classification of the question. For example, the computer system 110 can have one set of instructions to provide to the AI/ML model 132 for generating responses to ambiguous questions, a second set of instructions to provide to the AI/ML model 132 for generating responses to open-ended questions, and a third set of instructions to provide to the AI/ML model 132 for generating responses to standard questions. The different types of responses may use different types of data from the data set 122a associated with the chatbot, and so the selection of the workflow or instructions used can affect the data retrieval from the data set 122a also.

In stage (E), for a chatbot situation where results 176 are not already present in a dashboard or other document, the computer system 110 generates and sends a first request 172 to the AI/ML service provider 130 based on the prompt 170. The first request 172 can be a request for data retrieval code or instructions, e.g., a request for an LLM to generate a SQL statement or other criteria for retrieving and/or generating data from a data set. The first request 172 can include some or all of the prompt 170. The first request 172 can also include information about the types of data available in the data set 122a, such as a data model 149 or data schema for the data set 122a.

The first request 172 can be a request for an AI/ML model 132, such as an LLM, to generate code or instructions for a system (such as the database system 120) to use in retrieving and/or generating data to answer the prompt 170. For example, rather than asking the AI/ML model 132 to generate the answer to the prompt 170, the first request 172 can request a SQL statement, programming code, a list of operations, or other instructions that specify criteria that would retrieve and/or calculate the values needed to answer to the prompt 170. As a simple example, the prompt to the LLM in the first request 172 may include an instruction such as “provide a SQL statement that retrieves the data needed to answer the question <<user prompt>>,” or “generate Python code that can run on <<database system>> to calculate the answer to the question <<user prompt>>.”

By requesting code or instructions, the process takes advantage of the ability of AI/ML models 132 to reliably produce high-quality code or instructions expressed in programming languages (e.g., SQL, Python, Java, HTML, XML, etc.). This often generates in a more concise and unambiguous result than more free-form text outputs. This type of request guides or constrains the AI/ML model 132 to follow the conventions of a particular programming language (which can be specified in the request 172). Programming languages are usually designed to avoid ambiguity and to promote consistency in usage of terms across many different situations. As a result, code examples often demonstrate clear usage patterns that the AI/ML models 132 can learn from and follow.

Also, by requesting that the AI/ML model 132 create the code or instructions using a standardized format, such as SQL, this greatly increases the number of different AI/ML models 132 that can be used with the system. For examples, many different LLMs may have a capability to create SQL, while models, if any, may be able to reliably generate visualizations or descriptions of visualizations. With many different options for selecting an AI/ML model 132 to create SQL, the computer system 110 has the versatility to vary which AI/ML service provider or model is used (e.g., for cost, speed, load balancing, etc.) and the robustness to change which model is used if a AI/ML service provider or model becomes unavailable.

Requesting that the AI/ML model 132 create code or instructions for data retrieval takes advantage of strengths of LLMs, such as natural language interpretation of the user's prompt 170 and ability to generate text, such as code, that follows established patterns or rules. This also constrains the constrains the form of the output to a set of code or instructions, such as SQL or another standardized representation, which allows the high-quality results to be achieved reliably.

To enable the AI/ML model 132 to reference the appropriate logical data objects of the relevant data set 122a (“Data Set A”), the first request 172 includes the data model 149 for the data set 122a to be used. The data model 149 can include information about the data set(s) that the chatbot will use to respond to the request 172, usually without providing any of the actual content of the data set. For example, the data model 149 can include a data schema for the data set 122a. In general, the data model 149 can indicate a list of logical objects represented in the data set 122a, such as a list of the elements or components of the data set, such as metrics, attributes, facts, and so on. For example, the data model 149 can indicate that the data set 122a includes logical objects such as date, customer identifier, region code, sales amount, and so on. These data objects can represent quantities or data objects that are represented in, or can be derived from, data in the data set 122a. The logical objects, such as metrics or attributes, can represent the type of data that is stored in or derived from a column of data. For example, an attribute may represent a type of data stored in a column of a data table or the result that would be obtained by applying a particular arithmetic expression to data in a column. Similarly, a metric or fact can represent the result of applying a particular aggregation function or other operation(s) to values in one or more columns of a data table. Accordingly, the data model 149 can indicate the attributes and metrics that are available for the AI/ML model 132 to work with, and potentially additional attributes or metrics that can be generated or operations that are available for the database system 120 to create a new attributes or metrics.

In some cases, the data model 149 can indicate, through the logical objects identified, data from tables, columns, and other elements that make up the data set 122a, in addition to or instead of the semantic meanings and/or relationships among these elements of the data set 122a. For example, the data model 149 can indicate that the data set 122a includes set of data named “sales_table,” that includes a metric named “sales_amount” that indicates amounts of sales and another attribute named “region” that indicates the region in which the sale occurred. These quantities may or may not correspond directly to the structure of the data set 122a. For example, the item “sales_table” may be an actual data table of a database, or may not represent a table and instead another grouping of data. Similarly, the “sales_amount” and “region” objects may correspond to specific columns of a data table, but may alternatively represent values that can be calculated or otherwise derived from the data set 122a in another way. Providing the data model 149 can give the AI/ML model 132 a list and description of the logical objects that the database system 120 recognizes, so that code or instructions generated by the AI/ML model 132 can use the identifiers known to the database system 120 and/or the computer system 110. As a result, the AI/ML model 132 can generate code or instructions that reference these logical objects that are understood by the computer system 110 and the database system 120. To the extent that the objects indicated in the data model 149 differ from the actual structure of the data set 122a, the computer system 110 and the database system 120 can use convert from the logical object names used in the data model 149 to actual data set elements and functions.

The data model 149 can indicate the names or labels for these data elements, classifications of the elements (e.g., metric, attribute, etc.), and other information. In some implementations, the data model 149 can include sample data for the data set 122a, such as a sampling of data from the data set 122a. The sample data can be fictitious example data that may be artificially synthesized to be representative of the data in the data set 122a (e.g., similar types of data), without indicating actual contents of the data set 122a. The data model 149 can be provided in any of various forms, such as a database schema from a database management system, a list or definitions of objects, components, or identifiers of the data set 122a, etc.

By providing the data model 149 with the request 172, the computer system 110 provides the AI/ML model 132 the ability to make use of the logical objects specified in the data model 149. As a result, the AI/ML model 132 can determine the types of data that would be available from the data set 122a, even without the AI/ML model 132 having any access to the data set 122a. The AI/ML model 132 can generate code or instructions (e.g., a SQL statement) that references these logical objects, with a clear set of names or other identifiers to accurately and unambiguously reference components of the data set 122a. For example, providing the data model 149 for the data set 122a, may enable the AI/ML model 132 to reference logical objects in generated SQL statements that the computer system 110 and/or database system 120 can unambiguously map the logical objects to tables and columns of the data set 122a. This allows the AI/ML model 132 to distinctly and unambiguously define criteria to specify the subset or portion of data to be retrieved from, or calculated based on, the data set 122a.

In some implementations, the first request 172 includes additional information that assist the AI/ML model 132 to interpret and respond to the user prompt 170 and other information, such as a knowledge base 148. The knowledge base 148 can provide a mapping for the AI/ML model 132 to map words and phrases with non-standard or idiosyncratic meanings (e.g., jargon, nicknames, etc.) to definitions, descriptions, or other indications of their meaning. The knowledge base 148 can include information determined at any of multiple levels, such as at the level of an enterprise as a whole, for a department or group of individuals, or for a specific individual. Similarly, the knowledge base 148 can be one that has been created for a single chatbot or AI/ML application or one that is shared with multiple chatbots or AI/ML applications.

In some implementations, the computer system 110 enables the administrator 103 to attach one or more additional data sets to adjust the operation and output of the chatbot. For example, an additional data set can be a knowledge base 148 or data dictionary can be added. Unlike the primary data set that the user selects for the chatbot (e.g., data set 122a), the chatbot is not configured to answer questions about the additional data set or to retrieve metrics or to provide visualizations of the knowledge base 148. Instead, the knowledge base 148 can be provided to assist the chatbot in interpreting user queries and providing responses with the terminology for the user's organization. In general, the knowledge base 148 can function to provide contextual knowledge to the AI/ML models 132, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base 148 is designated for the chatbot to describe these and other internal terms. Each time the user submits a prompt, the knowledge base 148 can be provided to assist the LLM with the context that is appropriate for the company. The knowledge base 148 can provide information similar to a semantic graph, by describing entities and their relationships. In some cases, the information in the knowledge base 148 can be derived from a semantic graph 150 and then converted into text (e.g., unstructured, semi-structured, or structured) in a format that can be processed by the LLM.

In general, the knowledge base 148 or other additional data set can include data that maps terms or phrases to their meanings. In many cases, this can include semi-structured data or explanatory content, as a way to explain entities and relationships wo the AI/ML models 132. Although the knowledge base 148 may include definitions, more generally the information may include descriptions of people, roles, business units, products, and other terms that may be referenced. The administrator 103 may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases 148 as contextual data sets that can be applied consistently across the enterprise, for all chatbots created and used in the enterprise. Similarly, different departments within the enterprise may add their own particular contextual data sets that may supplement the enterprise-wide knowledge bases 148. In addition, specific contextual data sets can be added for specific chatbots. In this way, chatbots at different levels of an organization can inherit a consistent set of terminology and knowledge in an organization, which also makes maintaining the overall knowledge base much more simple. The knowledge bases 147 can additionally or alternatively be specified with a scope that corresponds to a computing environment, so that chatbots associated with a particular domain or server inherit the knowledge bases for that domain or server.

One of the advantages of the knowledge base 148 is consistency for many users and even for many different chatbots of an organization. The user submitting a prompt does not need to take any action to select or include the knowledge base 148 in the chatbot's processing, the chatbot automatically include the knowledge base 148 in its context for each prompt or question received. Also, because the knowledge base 148 can be shared or inherited by many chatbots within an organization, updating and maintaining the knowledge base 148 is simple. An edit to the knowledge base 148 is automatically applied to all of the chatbots associated with the organization, even if the chatbots were created by different administrators or provided to different sets of users.

In addition, the knowledge base 148 provides persistent context that is not lost from one prompt to another or from one session to another. The knowledge base content can also be implemented applied in a manner that the knowledge base 148 does not count toward the instruction token limits that the AI/ML models 132 consume for each response. Rather than counting toward the tokens for prompts and recent history, the knowledge base 148 can be accessed or provided to the AI/ML models 132 as a separate source of knowledge apart from the prompt and context, and so does not count toward the token limits of an LLM. Implementations of access to the knowledge base 148 can vary. For example, when a session with the chatbot is instantiated, the knowledge base can be provided as part of initializing the chatbot. In some cases, the AI/ML models 132 are additionally or alternatively configured to access the primary dataset and if the user prompt includes a term or makes a request for an item not specified in the primary dataset, the chatbot is configured for the AI/ML models 132 to then check the knowledge base or other contextual data sets. In some implementations, the knowledge base 148 can be prepared as an embedding, a vector database, or other format that can be accessed by or referred to by the AI/ML models 132.

The first request 172 can include additional information such as a conversation history for the user 105 and the chatbot, and/or a long-term memory 147 with information that persists across chat sessions. The history or memory 147 can represent any of various types of information that can be stored external to the AI/ML models 132 but captures information about previous sessions, previous conversations or previous text of the current conversation, preferences of one or more users, learning from feedback of one or more users, and so on. In some implementations, the chatbot is designed to have a long-term memory 147, which can store information learned from users in past interactions. For example, LLMs and other AI/ML models 132, on their own, are generally stateless and do not natively understand the user context or history of interactions with the user, especially from previous sessions. The computer system 110 can facilitate learning by the chatbot to provide infrastructure that creates a long-term memory 147 for the chatbot. For example, the long-term memory 147 can store items such as definitions of terms for a particular user context, unique text elements the chatbot might encounter, and feedback from prior user interactions.

One valuable aspect of the long-term memory 147 is the ability for the chatbot to learn and adapt from explicit or implicit user feedback over time. If a user asks questions, then gives feedback they were expecting something different (e.g., either through text of a prompt to the chatbot or through an external survey or rating), then the computer system 110 can capture that feedback and update the chatbot to better provide what the user intended in the future. For example, the computer system 110 may add or adjust the instructions to the chatbot to reflect the user expectations or preferences. In some cases, this may include changing the default response format or response instructions, or may include adding rules or explanations that are context-dependent (e.g., apply to specific phrases or prompt types). This learning may occur at different levels. For example, it may include learning that particular terms, phrases, or combinations of terms call for a particular type of response. As another example, the feedback may more shift answers generally in certain ways, e.g., to be more verbose, more concise, to add or change visualizations, to change the order of content, to add or adjust summary elements, and so on.

In stage (F), the AI/ML service provider 130 uses one or more of the AI/ML models 132 to generate a response to the first request 172. The AI/ML service provider 130 then sends the response, code or instructions 173, to the computer system 110. As discussed above, the first request 172 requests code or instructions specifying the criteria or data processing operations that can be used to retrieve and/or generate (e.g., calculate) from the data set 122a the result data that would be needed to answer the user prompt 170.

In response to the request 172, the AI/ML service provider 130 uses the AI/ML models 132 to generate the code or instructions 173 that specify the criteria to retrieve and/or generate the data needed to answer the prompt 170. This part of the process leverages the ability of the AI/ML models 132, e.g., LLMs, to generate a set or sequence of instructions or operations. The data processing instructions 174 can be expressed in any of a variety of ways, such as one or more SQL statements, as executable or interpretable code, such as Python code, as a list of API calls or commands to be executed, and so on. The code or instructions 173 can provide instructions for retrieving specific portions of one or more data sets, such as from the specific data set 122a specified in the prompt 170 or otherwise indicated to the AI/ML model 132 used. The code or instructions 173 can additionally or alternatively instruct various data processing steps or operations to be performed, including data joins, data aggregations, filtering data, evaluating expressions, creating new metrics and calculating their values, etc.

The computer system 110 uses the code or instructions 173 generated by the AI/ML model 132 to generate data processing instructions 174 to be processed by the database system 120. For example, the computer system 110 can analyze and update the code or instructions 173, such to modify the SQL statement from the AI/ML model 132 to an enhanced or improved SQL statement. As a result, the data processing instructions 174 can be a combination of code or instructions 173 from an AI/ML model 132 and changes or enhancements added by the computer system 110.

In stage (G), the computer system 110 uses the data processing instructions 174 to instruct the database system 120 to obtain (e.g., retrieve, calculate, generate, etc.) the data needed to answer the user prompt 170. For example, the computer system 110 may send a request that includes the data processing instructions 174 to the database system 120, in order to request the needed data.

In stage (H), the database system 120 generates and sends results 176 that include the data retrieved from and/or generated based on applying the data processing instructions 174 for the dataset 122a. The database system 120 processes or executes the data processing instructions 174 that it receives, which creates the results 176, which may be in any of various forms, such as records retrieved, data series, aggregations of data, statistics about data in the dataset 122a, subsets of the dataset 122a determined to be relevant, and so on.

In stage (I), the computer system 110 sends a second request 178 to the AI/ML service provider 130. The second request 178 includes the results 176 and requests that the AI/ML models 132 generate a response that answers the prompt 170 based on the results 176. For example, the second request 178 may be a request to answer the prompt 170 using the data in the results 176 as context. As another example, the second request 178 may be a request for the AI/ML models 132 to summarize the results 176, in addition to or instead of answering the user prompt 170.

This second request 178 can include instructions to the AI/ML model that are selected based on the classification result. For example, because the prompt 170 was classified as ambiguous, the computer system 110 includes instructions to generate answers based on each of multiple different interpretations. This way, the computer system 110 can provide examples of answers with different criteria for “best,” which means that the answers are more likely to include what the user 105 desired, and the answers also give the user 105 an opportunity to clarify the meaning to be used in the future. If the question classification had indicated an open-ended question instead, the type of response format would be different, such as to summarize the results 176 or provide detailed description of three different attributes or metrics, rather than providing answers using different interpretations as done for ambiguous questions.

As with the first request 172, the computer system 110 can provide user context data, a conversation history for the user 105, or other context information in or with the second request 178, so the AI/ML model 132 can generate a response based on the context of the user's situation and the user's previous conversations. The computer system 110 can also provide information from the knowledge base 148, the long-term memory 147, the data model 149, and so on.

In stage (J), the AI/ML service provider 130 uses the AI/ML models 132 to generate a response to the user prompt 170, e.g., a chatbot response 180 that includes natural language text providing the answer to the prompt 170 as determined from the results 176. For example, the second request 178 may include or provide access to the results 176 and the user prompt 170, and so the AI/ML models 132 generate a text response 180 to the prompt 170 from the values in the results 176. For example, in the illustrated example, the chatbot response 180 is text that one or more AI/ML models 132 generated that indicates the specific regions having the highest profit, as requested by the prompt 170, along with an indication of the profit values taken from the results 176.

In stage (K), the computer system 110 generates response data 182 and provides the response data 182 over the network 102 to the user device 106 as the response of the chatbot. For example, the response data 182 can include the text of the chatbot response 180. In this case, the response data 182 includes an answer based on the default or most likely interpretation, e.g., “Our New York City location has received the most awards,” which uses the interpretation of “best location” to be the one that has won the most awards. In addition, additional answers are provided for other interpretations or other criteria for deciding what is the “best location,” with answers of “Our newest location is in San Diego.” for criteria of age, “Our largest location is in Denver.” for criteria of size, and “Our location with the highest sales is in Boston.” for criteria of highest sales.

In stage (L), the user device 106 receives the response data 182 and displays the response data 182 in the user interface 162. For example, the user device 106 presents a primary chatbot response 180. The user device 106 also presents the additional or alternative answers as a response 190. As shown in the example user interfaces, alternative answers can be made selectable so that the user 105 can indicate which alternative answer, if any, is based on the interpretation or criteria that the user intended. The computer system 110 stores indications of those selections, for each user, to learn each user's preference. In the future, if an ambiguous question is detected for the user 105, but the computer system 110 has records indicating a previous preference or interpretation was selected by the user, then the system 110 can use that interpretation without showing alternative answers.

As an example of responding to an open-ended question, a user may be viewing a dashboard with information about finances in the U.S. economy. The user submits a question, “can you analyze the trends in the US's goods exports and imports over the last five years?” In response, the computer system 110 as part of its processing requests that the AI/ML model 132 classify the question, and the AI/ML model 132 classifies it as open-ended. In response, the computer system 110 generates instructions to an the AI/ML model 132 to broadly describe a summary of the data presented in the dashboard. This can be based on a custom instruction that an administrator or document creator specified for open-ended question, or can be based on a default instruction for open-ended questions (e.g., “summarize the data represented in . . . ” a particular table, visualization, or other part of a document. Based on the instruction, and using the result data corresponding to the portion of the dashboard the user is viewing, the system can provide a response, such as:
Overall Trends: Over the last five years, the US has seen a fluctuating trend in goods exports and imports. Starting with a period of growth in both exports and imports from 2018 to 2019, there was a significant dip in 2020 due to global trade disruptions caused by the pandemic. However, recovery was evident in 2021 and continued into 2022, with exports growing at a slightly faster rate than imports. This recovery can be attributed to easing global restrictions and a resurgence in international demand.
Major Trade Partners: Throughout this period, China, Canada, and Mexico remained the top trade partners for both exports and imports. While trade tensions affected the volume of trade with China, particularly in 2019 and 2020, Canada and Mexico showed more stability due to the USMCA agreement. The trade with these countries showed resilience, with Mexico becoming an increasingly important partner for exports by 2022.
Notable Categories: In terms of categories, technology products (especially semiconductors), automotive parts, and pharmaceuticals led US exports, showing robust growth except for the pandemic-affected year. Imports were dominated by electronics, machinery, and textiles, with a notable increase in pharmaceutical imports during 2020 due to the health crisis. The “Export End-Use category” and “Import End-Use Category” reveal that while technology and automotive sectors have been strong export areas, the US continues to rely heavily on imported electronics and machinery.

As another example, a user provides a prompt, “Show me some insights on income for different income categories in 2023?” The computer system 110, using a classification of the question from the AI/ML model 132, detects the question as open-ended. In response, the computer system 110 coordinates for the AI/ML model to provide a broad answers, summarizing the result data represented in the current view of the dashboard or other document being shown, to provide an answer such as:
Overall Income Trends: The year 2023 saw a nuanced shift in personal income trends across the United States. Overall, there was a moderate increase in personal income levels, attributed to economic recovery efforts and job market improvements. This growth was not uniform across all sectors, with technology, healthcare and renewable energy industries seeing the most significant wage increases. The “Personal Income Total” metric suggests an aggregate rise, but with notable variations when dissected by income category and industry.
Disparities Among Income Categories: Analyzing the “Income per category” data reveals widening income disparities between the highest and lowest income categories. High-income categories, often associated with advanced sectors like technology and finance, reported above-average income growth. In contrast, categories tied to service and traditional manufacturing sectors experienced minimal growth, highlighting persistent income inequality issues. The disparities were particularly evident in metropolitan vs. rural comparisons, where economic opportunities diverge significantly.
Impact of External Factors: External factors played a crucial role in shaping income trends in 2023. Policy changes, including adjustments to tax structures and minimum wage laws, had a direct impact on disposable income levels in different categories. Moreover, inflation rates and the cost of living adjustments varied widely across regions, affecting real income growth. The global economic landscape, marked by trade negotiations and supply chain adjustments, also influenced income dynamics, especially in export-driven industries.

In general, the computer system 110 leverages an LLM to assess if a user's question is open-ended. The LLM can analyze the question's structure, key phrases, and contextual cues based on the underlying data to detect if a question is open-ended. Once an open-ended question is identified, the system 110 instructs the LLM to generate an in-depth commentary addressing the primary query across three aspects. The response should be wide-ranging yet closely related to the original query. As an example, a user submits the question, “Tell me about the trends in activities in 2019.” The computer system 110, once the question is determined to be open-ended, provides a request for the LLM to analyze activity data from 2019, identifying not only the most popular activities by count but also examining trends over the months, comparing activity preferences across different seasons, and exploring any external factors (such as weather conditions or public events) that might have influenced these trends. These features can be specified in advance by the document creator or an administrator, or may be extracted from the content of the dashboard or document. The LLM can then provide an answer such as “In 2019, the landscape of activities saw a variety of trends, with ‘Morning Ride’ topping the list as the most frequently engaged activity, boasting 11 occurrences. This was closely followed by ‘Friday evening commute’ and ‘Morning Run,’ each reflecting the community's preference for starting and ending their days actively. A seasonal analysis reveals a spike in outdoor activities during the warmer months, with a notable shift towards indoor exercises as the weather cooled. External factors, such as public events and city-wide sports initiatives, also played a role in influencing these preferences, encouraging more communal and organized activities. The data not only highlights the community's active lifestyle but also underscores the impact of environmental and societal factors on their activity choices throughout the year.”

In responding to open-ended questions, the system can leverage user-level learning (e.g., personal preferences) to ensure answers to open-ended answers are tailored to the user's profile and interests. For example, if a user has previously stated to include week-level revenue numbers when querying about sales performance, and now the open-ended query is: “Tell me about sales performance in the Atlanta store?” the computer system 110 should store and provide to the AI/ML model the user's preference for weekly analysis, so the results surface relevant results.

Answers to open-ended questions can also make use of available knowledge assets, such as a knowledge base for an organization, while generating answers. Like other answers, users can be provided mechanisms to indicate like or dislike of the answers received to open-ended questions. If there is something to be learned from the interaction, the system records it and displays the learning to the end user.

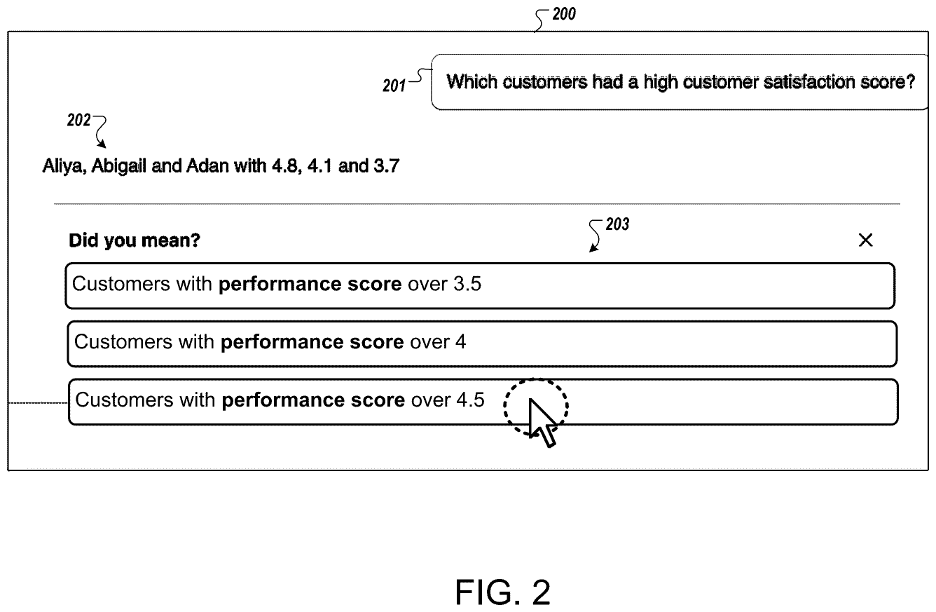

FIG. 2 shows a user interface 200 with another example of a question 201 that is determined to be ambiguous, a default answer 202, and multiple alternative answers 203 provided in response that use different criteria or interpretations.

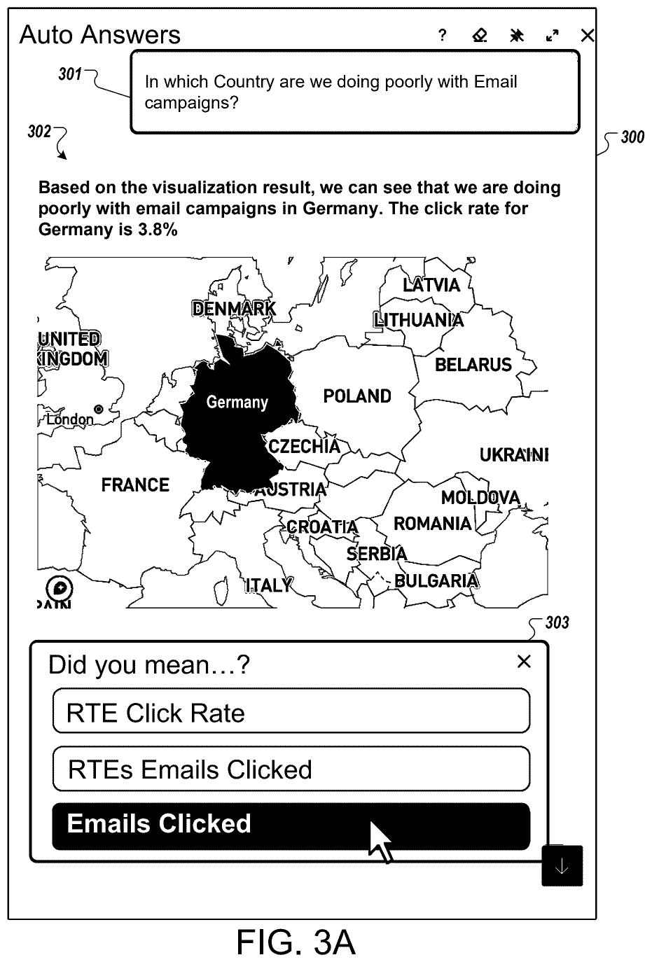

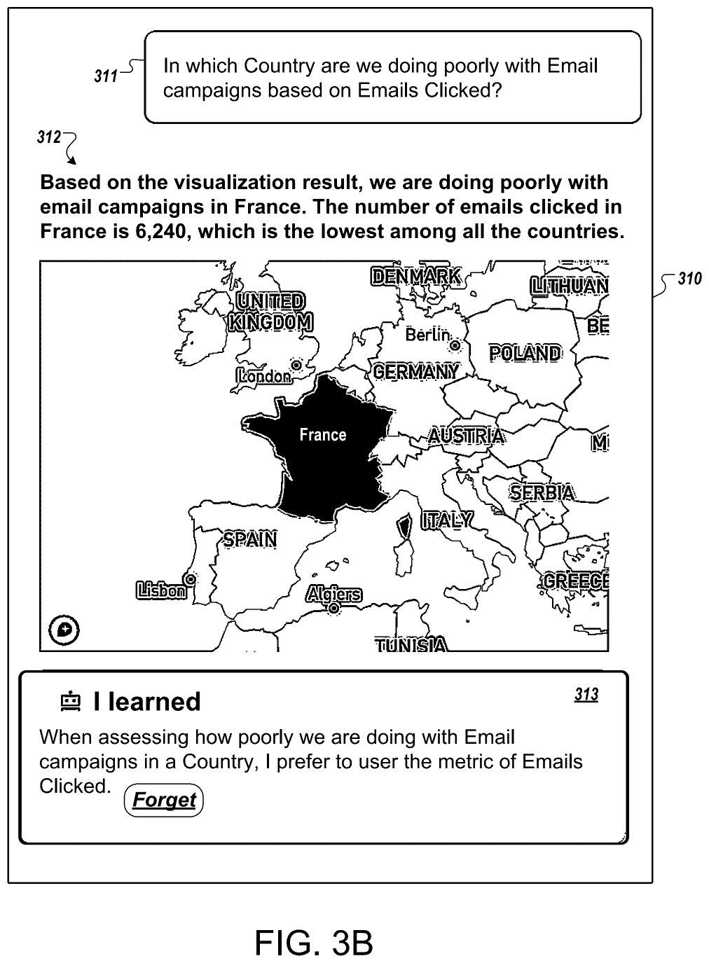

FIG. 3A shows another user interface 300. User submitted a question 301, and a default answer 302 is provided. Because the question 301 was classified as ambiguous, this system also generates and provides alternative options for interpreting the concept of performance inherent in the question 301. In this case, the options 303 specify different metrics that can be used as criteria to specify how performance should be judged.

FIG. 3B shows an example where, after the interactions of FIG. 3A, the user submits a later question 311 that refers to the same concept of performance in the same context of countries and emails being clicked. At this time, because the system has previously learned the user's preference from a selection among the options 303, the system provides an answer through 12 and does not provide alternatives. Instead, the system provides a notice 313 about the criteria used, and gives the user an opportunity to forget the learned information if it is incorrect.

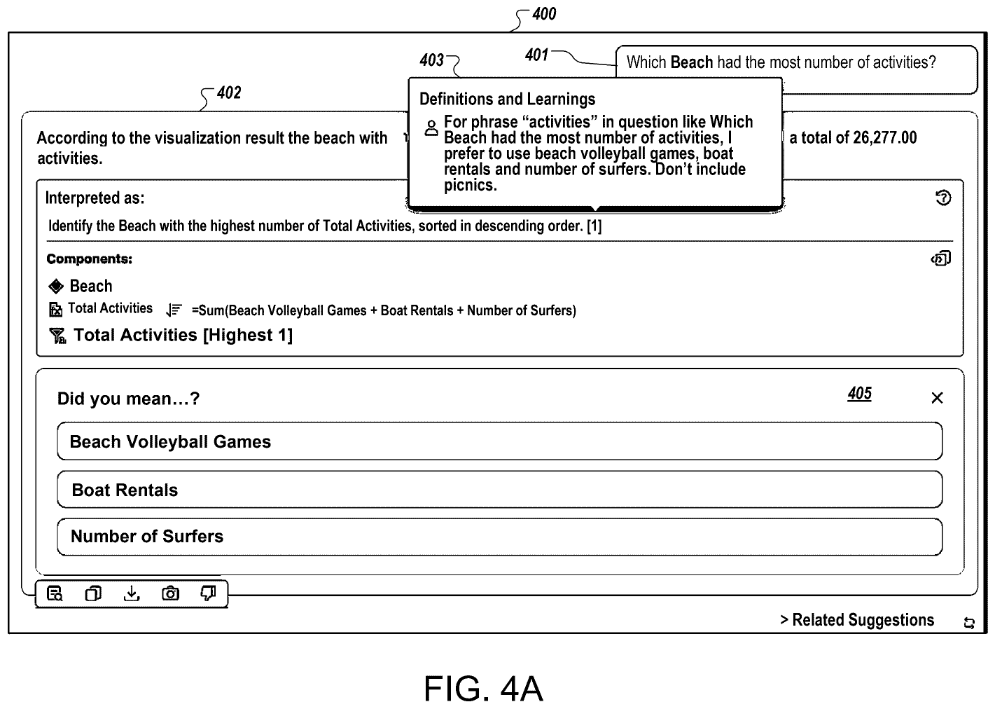

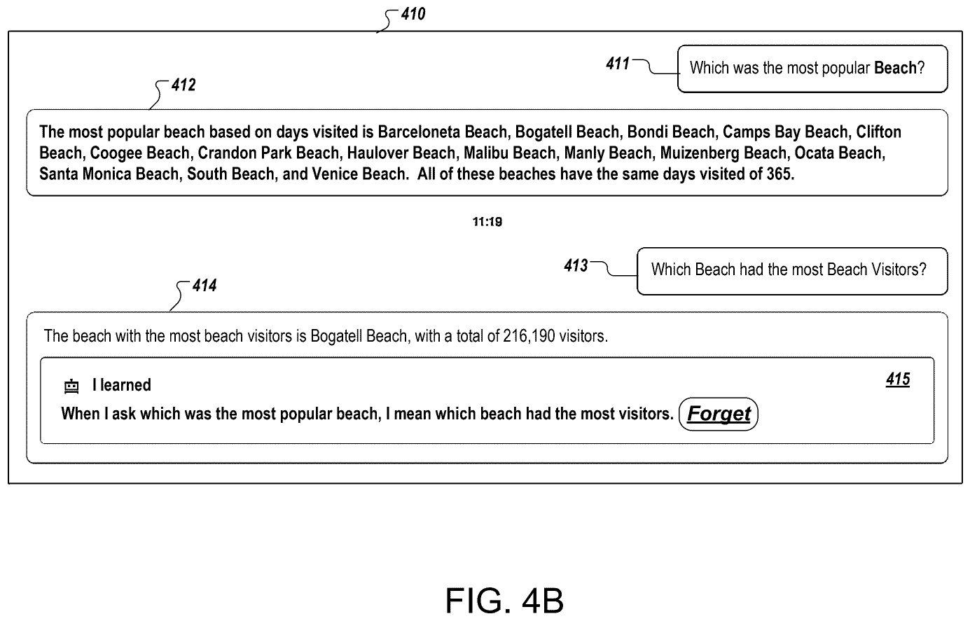

FIG. 4A shows an example user interface 400 where the user submits a question for one, and a response 402 is provided. The response for two includes information describing the interpretation of the users question 401 including specifying which data objects or formulas were used to arrive at the answer. The user interface 400 also shows an indicator 403 showing what was learned from previous interactions. In this example, alternative interpretations are also provided in an answer region 405.

FIG. 4B shows another user interface 410, showing a user question 411 (“Which was the most popular Beach?”) and an chatbot answer 412 that uses an interpretation of what “most popular” to be the beach that was visited the most days in the last year. The user responds with a follow-up question 413 that asks about which Beach had the most visitors, and the computer system 110 detects that the user's question indicates that a different interpretation of “most popular” in the context of beaches was intended. The chatbot response 414 is provided with a learning statement 415 showing what the system learned, e.g., what will be stored and used for future interpretations.

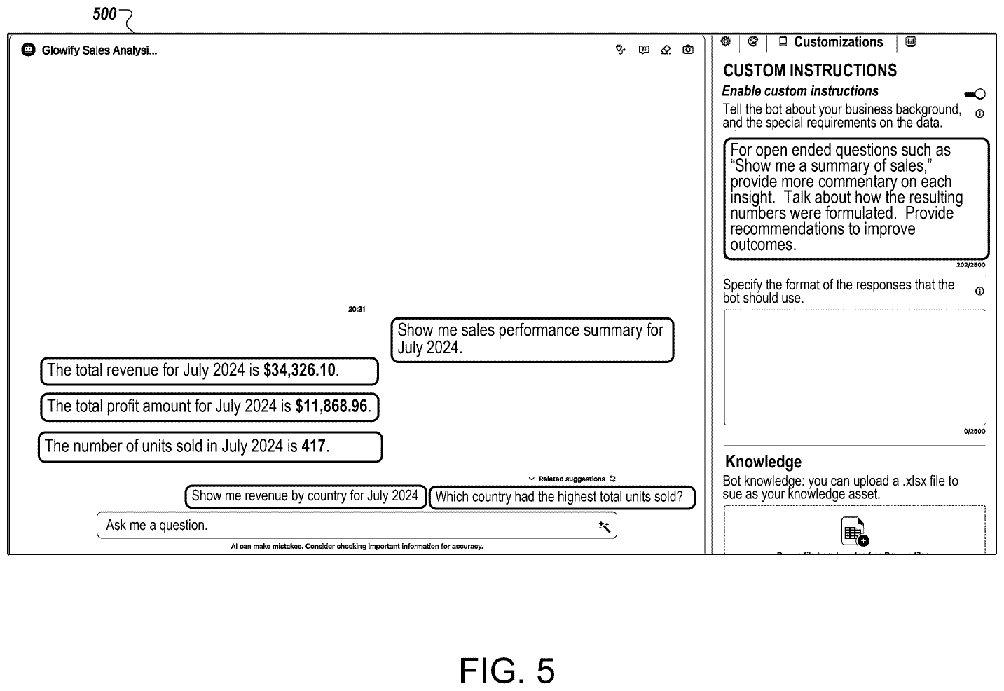

FIG. 5 shows a user interface 500 that includes a panel at the right where an administrator can specify custom instructions for a chatbot. For example, an administrator can customize the behavior of a chatbot by specifying the type of content, format, and other parameters to be used when a question of a particular classification is detected. For example, this shows a particular set of instructions to provide to the chatbot when the question is determined to be open-ended. At the left, there's an example of an open-ended question, where the time range of July 2024 is well defined, but the request for a sales performance summary is very broad and open-ended. An example of the output that would be produced by the custom instruction is shown by the three example data points provided in response.

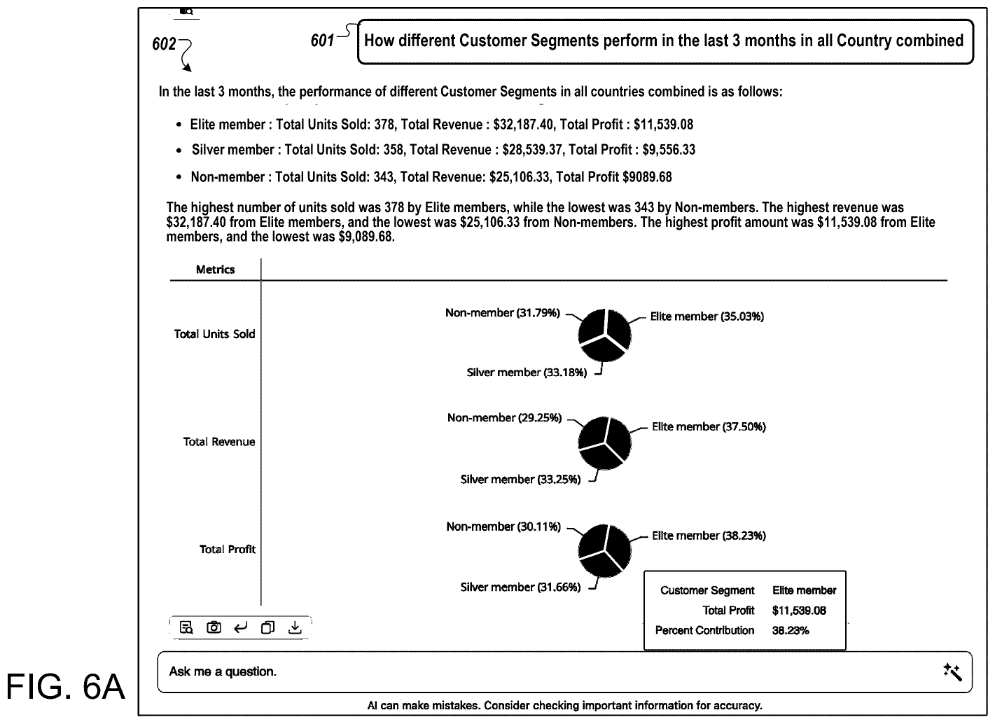

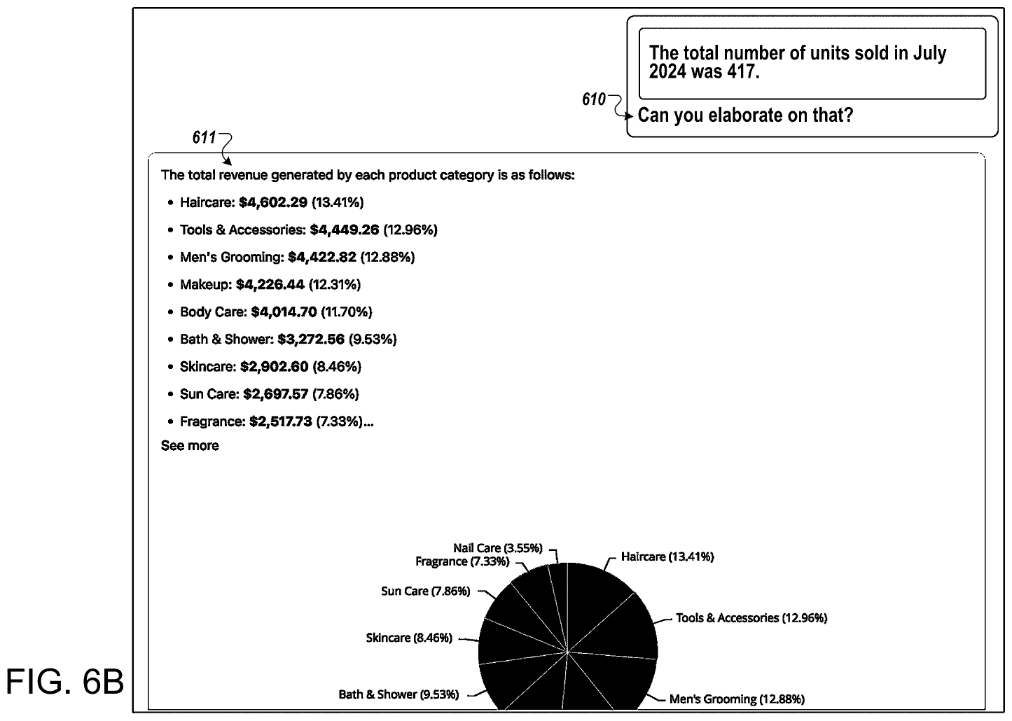

FIG. 6A is another example user interface 600, showing a broad question and summary view of the specified topic provided in response. The user's question 601, “How different Customer Segments perform in the last 3 months in all Country combined,” is answered with a chatbot response that describes the customer segments and time range requested. The response 602 provides information about three metrics (e.g., Total Units Sold, Total Revenue, and Total Profit), and includes values for each customer segment, as well as comparison information such as the highest and lowest values for each metric across the customer segments.

FIG. 6B shows an example of answering an open-ended question. A user submitted a question “how many units were sold in July 2024,” and the chatbot response was “The total number of units sold in July 2024 was 417. The user then asks a follow up question 610, “can you elaborate on that?” The computer system 110 uses the AI/ML models 132 to classify the question as open-ended, and so generates and provides a response 611 with further detail in response.

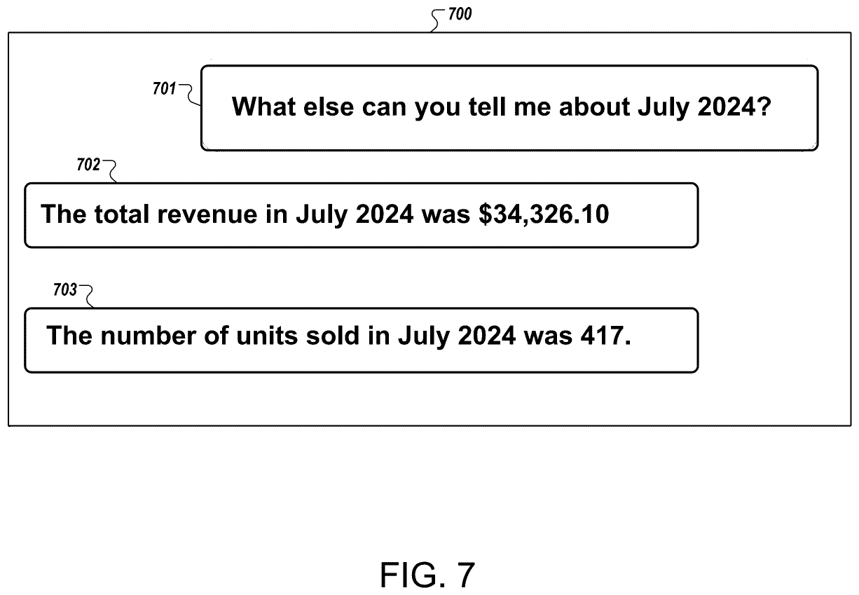

FIG. 7 shows another example of a broad question 701 and multiple types of data shown in responses 702 and 703. Because the question 701 was classified by the computer system 110 and AI/ML models 132 as open-ended, the chatbot response can provide multiple responses or multiple items of information in a response. For example, when a open-ended question is detected, the instructions can cause the AI/ML model 132 to provide information about additional attributes, metrics, or other data objects that the data source has information about, while retaining the level of filtering or data aggregation specified by the user, e.g., in this case, the time period of July 2024.

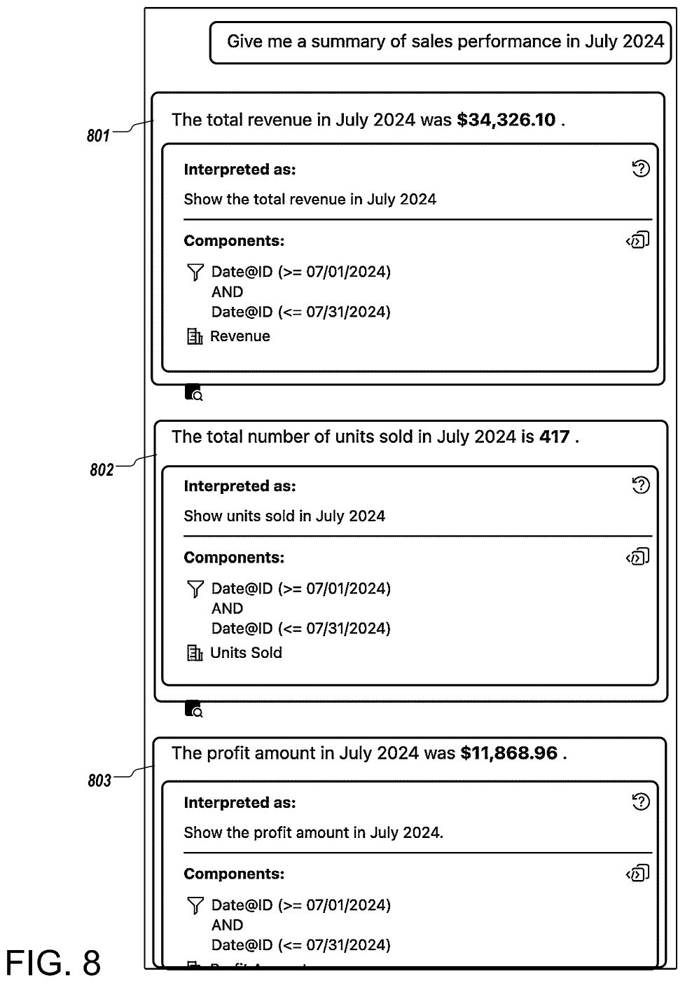

FIG. 8 shows a chatbot interface with a broad or open-ended user question, and three types of information provided in responses 801, 802, and 803. Here, the answers have been expanded to show a natural language interpretation as well as the data objects or components of a data set that were used to generate those answers. When a user prompt is classified as broad or open ended, the instructions to the AI/ML models 132 can be to select a number of data objects (e.g., the top 3 metrics most commonly or recently used in the context, or for the data set) and provide information for each of those data objects.

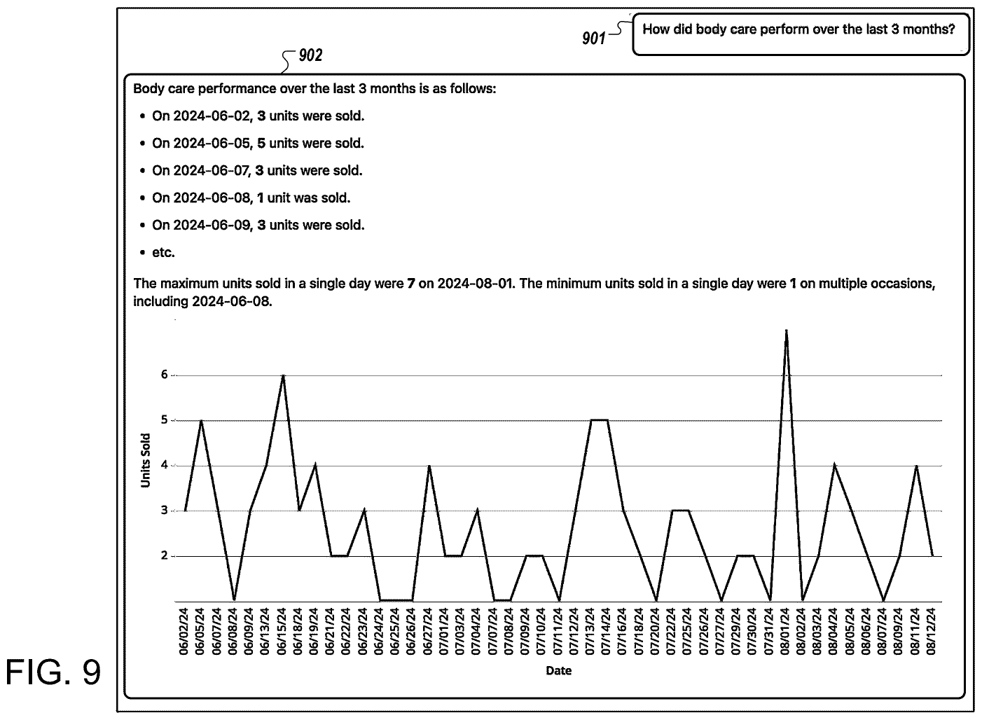

FIGS. 9-11B are further examples of broad questions or open-ended questions that were classified as being open-ended for at least one aspect, together with various types of response data returned to the user for those questions.

FIG. 9 shows an example where the user provided the question 901,“How did body care perform over the last 3 months?” Based on the classification of the question 901 and the corresponding instructions, the AI/ML model 132 provides a response 902 including a variety of information about sales, including sales amounts on specific days, a minimum and maximum over the time period, and a chart of units sold over time. The instructions to the AI/ML model 132 can provide guidance of what information to present in cases where the question is broad or open ended, such as to show a sample of data (e.g., 5 data points), a maximum and minimum, and a chart or graph. The information can be provided for one or more metrics or other data objects identified to be relevant based on the user's question, the conversation history, the configuration of the chatbot and its data sets, and so on.

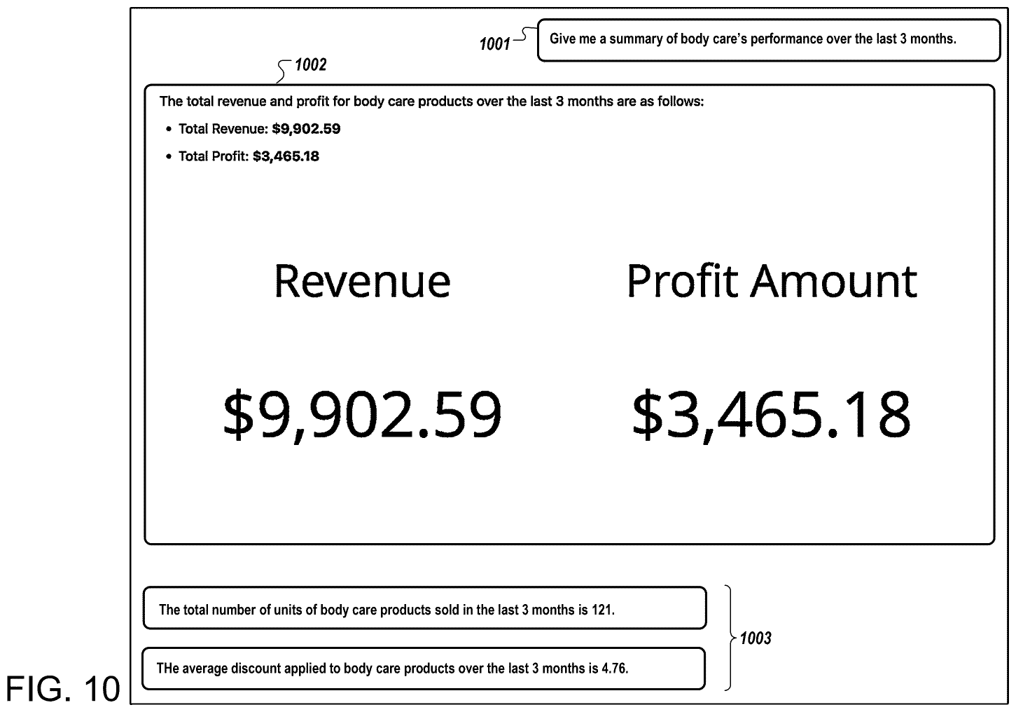

FIG. 10 is an example in which a user's question 1001 requests a summary, and the chatbot responds with multiple answers 1002, 1003. The type of information n an answer to a question for a general type of data, e.g., a summary, can be based on predetermined instructions or output formats that are provided to an AI/ML model 132 when the corresponding question classification or situation is detected.

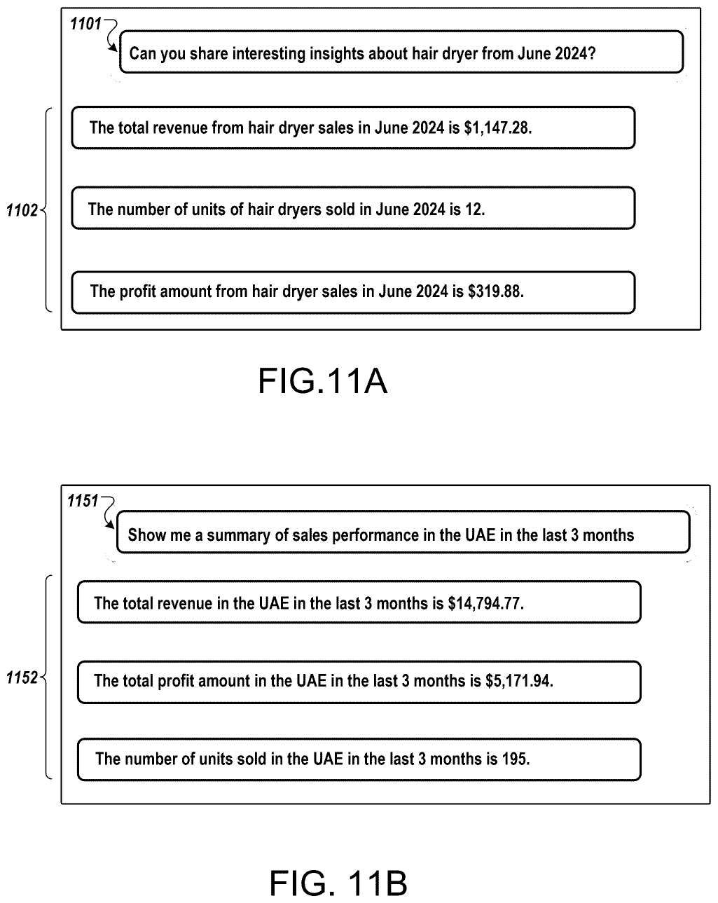

FIG. 11A shows an example in which a user question 1101 results in three responses 1102, each corresponding to a different metric or data object. Similarly, in FIG. 11B, the user question 1151 results in three different responses 1152. These examples show a predetermined pattern that the computer system 110 uses to answer broad or open-ended questions, such as asking for a “summary” or “interesting insights.” The computer system 110 can trigger the appropriate question handling instructions for a wide variety of different user words and phrasings that are open-ended, because the computer system 110 can use the AI/ML models 132 to classify the question rather than the computer system 110 relying on finding matches to specific terms.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

1. A method performed by one or more computers, the method comprising:
receiving, by the one or more computers, a text input from a user, wherein the text input is received over a communication network from a client device;
classifying, by the one or more computers, the text input as containing an ambiguity;
based on classifying the text input as containing an ambiguity, sending, by the one or more computers and to the client device, (i) a response to the text input generated using a first interpretation or meaning and (ii) one or more alternative interpretations or meanings that each resolve the ambiguity differently than the first interpretation or meaning;
after sending the response and the one or more alternative interpretations, receiving, by the one or more computers, data indicating user input that selects one of the one or more alternative interpretations; and
in response to receiving the data indicating the user input, sending, by the one or more computers and to the client device, a second response generated using the selected alternative interpretation or meaning.

2. The method of claim 1, comprising in response to receiving the user input, storing data indicating the selected alternative interpretation or meaning in association with a user identifier for the user; and
wherein the one or more computers are configured to use the selected alternative interpretation or meaning to respond to future input from the user.

3. The method of claim 2, wherein storing the data indicating the selected alternative interpretation or meaning comprises storing text representing the selected alternative interpretation or meaning in a vector database.

4. The method of claim 3, wherein storing the text representing the selected alternative interpretation or meaning comprises:
generating a vector embedding of the text representing the selected alternative interpretation or meaning; and
storing the text representing the selected alternative interpretation or meaning in association with the vector embedding.

5. The method of claim 2, wherein the ambiguity corresponds to a term or concept of the text input;
wherein the method includes, after storing the data indicating the selected alternative interpretation or meaning in association with a user identifier for the user:
receiving a second text input from the user, wherein the second text input includes the term or concept;
selecting the stored text representing the selected alternative interpretation or meaning based on the second text input; and
using the stored text representing the selected alternative interpretation to generate a response to the second text input.

6. The method of claim 5, wherein selecting the stored text representing the selected alternative interpretation comprises:
generating a vector embedding for the second text input;
evaluating similarity or distance of the vector embedding for the second text input with respect to vector embeddings of stored items associated with the user; and
selecting the stored text representing the selected alternative interpretation based on similarity of the vector embedding for the second text input and a vector embedding of the text representing the selected alternative interpretation or meaning.

7. The method of claim 2, comprising, in response to receiving a second text input from the user in a different session or conversation than the one in which the text input was provided, performing result-augmented generation (RAG) including (i) selectively retrieving one or more items saved based on user interactions with a chatbot from a vector database, and (ii) generating a response to the second text input based on the retrieved one or more items.

8. The method of claim 7, wherein the one or more retrieved items are each text segments, and wherein generating the response to the second text input comprises providing the second text input and the one or more retrieved items to a artificial intelligence and/or machine learning model to generate the response to the second text input.

9. The method of claim 1, comprising causing one or more interactive user interface elements corresponding to each of the one or more alternative interpretations or meanings to be displayed at the client device, wherein the one or more interactive user interface elements are each selectable to designate a corresponding alternative interpretation or meaning to be used.

10. The method of claim 1, wherein the one or more alternative interpretations or meanings comprise multiple alternative interpretations or meanings.

11. The method of claim 1, wherein the first interpretation or meaning and the alternative interpretations or meanings each comprise at least one of:
a mapping of a terms to a data object of a data model or data set;
one or more criteria for sorting, filtering, or ranking; or
a threshold value.

12. The method of claim 1, wherein the text input is a user prompt entered in a chatbot interface.

13. The method of claim 1, wherein classifying the text input comprises sending a request for an artificial intelligence and/or machine learning (AI/ML) model to classify the text input.

14. The method of claim 13, wherein the request includes a request to indicate whether the text input corresponds to one of multiple different categories that include a category of an ambiguous question and a category of an open-ended question.

15. The method of claim 1, wherein classifying the text input comprises requesting for an artificial intelligence and/or machine learning (AI/ML) model to (i) identify an ambiguous term or concept from the text input, (ii) determine multiple interpretations for the ambiguous term or concept, and (iii) provide responses to the corresponding to each of two or more of the multiple interpretations; and
wherein the one or more alternative interpretations include interpretations indicated by the AI/ML model.

16. The method of claim 15, wherein sending the second response comprises sending a response based on a response that corresponds to the selected one of the one or more alternative interpretations, wherein the second response was generated by the AI/ML model before the one or more alternative interpretations were sent to or displayed to the user.

17. A system comprising:
one or more computers; and
one or more computer-readable media storing instructions that are operable, when executed by the one or more computers, to cause the system to perform operations comprising:
receiving, by the one or more computers, a text input from a user, wherein the text input is received over a communication network from a client device;
classifying, by the one or more computers, the text input as containing an ambiguity;
based on classifying the text input as containing an ambiguity, sending, by the one or more computers and to the client device, (i) a response to the text input generated using a first interpretation or meaning and (ii) one or more alternative interpretations or meanings that each resolve the ambiguity differently than the first interpretation or meaning;
after sending the response and the one or more alternative interpretations, receiving, by the one or more computers, data indicating user input that selects one of the one or more alternative interpretations; and
in response to receiving the data indicating the user input, sending, by the one or more computers and to the client device, a second response generated using the selected alternative interpretation or meaning.

18. The system of claim 17, comprising in response to receiving the user input, storing data indicating the selected alternative interpretation or meaning in association with a user identifier for the user; and
wherein the one or more computers are configured to use the selected alternative interpretation or meaning to respond to future input from the user.

19. The system of claim 18, wherein storing the data indicating the selected alternative interpretation or meaning comprises storing text representing the selected alternative interpretation or meaning in a vector database.

20. One or more non-transitory computer-readable media storing instructions that are operable, when executed by one or more computers, to cause the one or more computers to perform operations comprising:
receiving, by the one or more computers, a text input from a user, wherein the text input is received over a communication network from a client device;
classifying, by the one or more computers, the text input as containing an ambiguity;
based on classifying the text input as containing an ambiguity, sending, by the one or more computers and to the client device, (i) a response to the text input generated using a first interpretation or meaning and (ii) one or more alternative interpretations or meanings that each resolve the ambiguity differently than the first interpretation or meaning;
after sending the response and the one or more alternative interpretations, receiving, by the one or more computers, data indicating user input that selects one of the one or more alternative interpretations; and
in response to receiving the data indicating the user input, sending, by the one or more computers and to the client device, a second response generated using the selected alternative interpretation or meaning.
